(19) United States
(12) Patent Application Publication
(10) Pub. No.: US 2026/0073903 A1
(43) Pub. Date: Mar. 12, 2026

(54) AUGMENTING AUDIO OF COMMUNICATION SESSIONS WITH TRANSCRIBED VISUAL CONTENT

(71) Applicant: Cisco Technology, Inc., San Jose, CA (US)

(72) Inventor: Raymond Michael Fallon, Co. Galway (IE)

(21) Appl. No.: 18/883,166

(22) Filed: Sep. 12, 2024

(51) Int. Cl. G10L 13/02; G06F 40/194

(52) U.S. Cl. CPC G10L 13/02; G06F 40/194

(57) ABSTRACT

An example embodiment enables users to have a richer experience by augmenting an audio stream or soundtrack of an online meeting with relevant information that was visually presented to participants (but absent from the soundtrack). The example embodiment may also help visually impaired users obtain information provided by visually presented content in a meeting. The example embodiment creates an audio stream from an audio-visual (AV) presentation using a variety of techniques. The example embodiment accommodates a variety of video content, including static text and pictures, while interpreting video and content that cannot be represented sensibly in an audible fashion. The audio and visual content of the presentation is processed from a recording of the presentation. Further, the example embodiment may apply to live meetings where a user is unable to view the visual content which reduces the effectiveness of the meeting.

### TECHNICAL FIELD

The present disclosure relates to online communication or collaboration systems.

### BACKGROUND

Some business professionals have busy lives and spend time on numerous online and in-person meetings (some of which may overlap), attendance at all meetings becomes difficult and there is insufficient time to view webinars. When a user wants to play a recording of a meeting or webinar, this may occur while the user is traveling or is in a situation where visual content that is being shared in the meeting cannot be viewed (e.g., walking, running, a person may be visually impaired, etc.). However, the visual content may provide pivotal information for the meeting and, even if the information provided by the visual content is trivial, the information may still be desired.

### BRIEF DESCRIPTION OF THE DRAWINGS

FIG. 1 is a block diagram of an example online communication environment in which incorporation of transcribed visual content into audio of a communication session may be implemented, according to an example embodiment.

FIG. 2 illustrates a block diagram of a configuration for incorporating transcribed visual content into audio of a communication session, according to an example embodiment.

FIG. 3 illustrates an example user interface screen for presenting content of a communication session, according to an example embodiment.

FIG. 4 is a flowchart of a method for incorporating transcribed visual content into audio of a communication session, according to an example embodiment.

FIG. 5 is a flow diagram of a method for incorporating transcribed visual content into audio of an example communication session, according to an example embodiment.

FIG. 6 illustrates a flowchart of a generalized method for incorporating transcribed visual content into audio of a communication session, according to an example embodiment.

FIG. 7 illustrates a hardware block diagram of a computing device configured to perform functions associated with incorporating transcribed visual content into audio of a communication session as discussed herein, according to an example embodiment.

### DETAILED DESCRIPTION

### Overview

An example embodiment enables users that can only listen to a recording of a meeting or webinar (e.g., due to driving a vehicle, performing physical exercise, etc.) to have a richer experience by augmenting an audio stream or soundtrack of the meeting with relevant information that was visually presented to participants (when the visually presented information is not already described in the audio soundtrack). The example embodiment may also help visually impaired users obtain information provided by visually presented content in a meeting or webinar. The example embodiment creates an audio stream from an audio-visual (AV) presentation using a variety of techniques. The example embodiment accommodates a variety of video content, including static text and pictures, while interpreting video and content that cannot be represented sensibly in an audible fashion. The audio and visual content of the presentation is processed from a recording of the presentation. Further, the example embodiment may apply to live meetings where a user is unable to view the visual content which reduces the effectiveness of the meeting.

### Example Embodiments

A method is presented herein that enables users that can only listen to a recording of a meeting or webinar (e.g., due to driving a vehicle, performing physical exercise, etc.) to have a richer experience by augmenting an audio stream or soundtrack of the meeting with relevant information that was visually presented to participants. These techniques can help visually impaired users obtain information provided by visually presented content in a meeting or webinar. The method involves creating an audio stream from an audio-visual (AV) presentation. A variety of video content can be accommodated, including static text and pictures, and video and content that cannot be represented sensibly in an audible fashion can be interpreted. The audio and visual content of the presentation is processed from a recording of the presentation. These techniques may apply to live meetings for which a user is unable to view the visual content which can reduce the effectiveness of the meeting.

While the present embodiments are described with respect to online meetings, it will be appreciated that the techniques may be performed for any collaboration, communication, or other sessions (e.g., meetings, chats, conversations or other threads, webinars, any types of sessions with visual content, etc.). Further, the present embodiments may be applied to any type of content providing information visually (e.g., text, images, video, whiteboard, links, etc.).

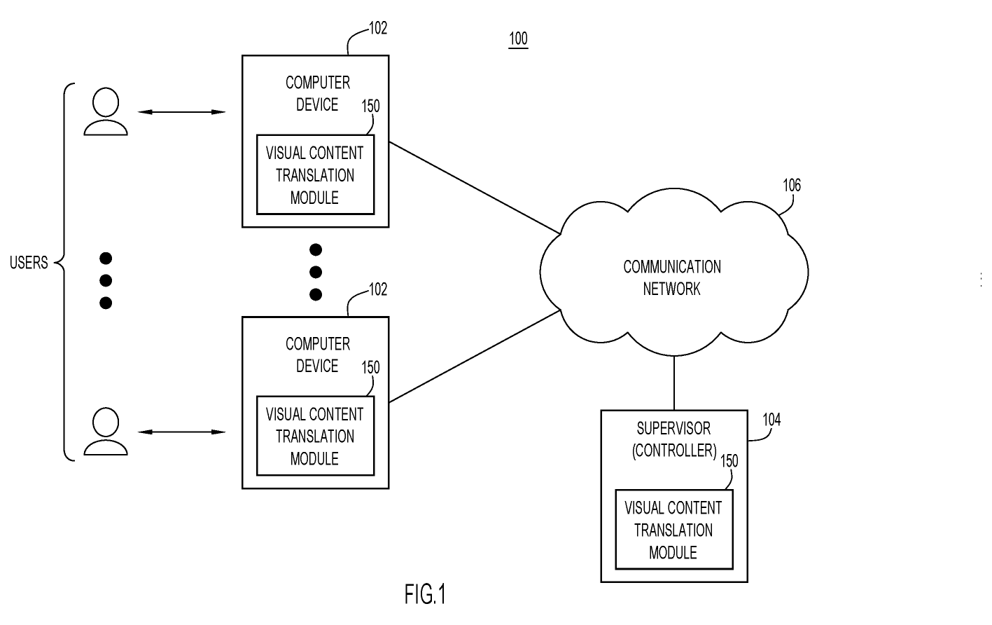

FIG. 1 illustrates a block diagram of an example online communication or collaboration environment 100 in which an embodiment presented herein may be implemented. Environment 100 includes multiple computer devices 102 (collectively referred to as computer devices, participant devices, or platforms) operated by local users/participants, a supervisor or server (also referred to as a “controller”) 104 configured to support online (e.g., web-based or over-a-network) communication or collaborative sessions (e.g., meetings, chat, conversations or other threads, webinars, etc.) between the computer devices, and a communication network 106 communicatively coupled to the computer devices and the supervisor. Computer devices 102 can take on a variety of forms, including a smartphone, tablet, laptop computer, desktop computer, video conference endpoint, and the like.

Communication network 106 may include one or more wide area networks (WANs), such as the Internet, and one or more local area networks (LANs). Computer devices 102 may communicate with each other, and with supervisor 104, over communication network 106 using a variety of known or hereafter developed communication protocols. For example, the computer devices 102 and supervisor 104 may exchange Internet Protocol (IP) data packets, Realtime Transport Protocol (RTP) media packets (e.g., audio and video packets), and so on.

Supervisor 104 or other server system coupled to communication network 106 may host a visual content translation module 150. According to embodiments presented herein, visual content translation module 150 enables incorporation of transcribed visual content into audio of a communication session as described below. Computer devices 102 may each host a communication or collaboration application used to establish/join online communication or collaboration sessions. In an embodiment, computer devices 102 may host visual content translation module 150 to incorporate transcribed visual content into audio of a communication session in substantially the same manner described below. Meetings or communication sessions of a user of a computer device 102 may be provided to visual content translation module 150 on computer device 102 and/or supervisor 104 for processing.

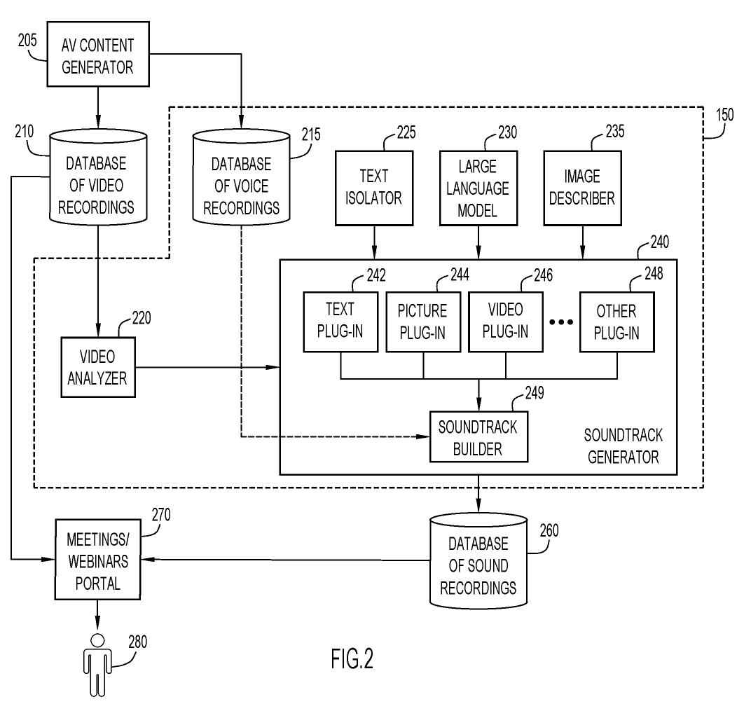

With continued reference to FIG. 1, FIG. 2 illustrates an example block diagram of a configuration for incorporating transcribed visual content into audio of a communication session, according to an example embodiment. The configuration includes visual content translation module 150, an audio-visual (AV) content generator 205, a video recordings database 210, a sound recordings database 260, and a meetings/webinars portal 270 to present a recording of the meeting or other communication session (with transcribed visual content) to a user 280. Visual content translation module 150 processes a recording of a meeting or other communication session in video recordings database 210 to transcribe visual content of the meeting and incorporate an audio description of the transcribed visual content into an audio stream (or soundtrack or sound recording) of the meeting. The resulting sound recording is stored in sound recordings database 260 for presentation to user 280 via meetings/webinars portal 270.

AV content generator 205 may include any conventional or other devices to generate content from a communication session (e.g., meeting, webinar, etc.). The output of the AV content generator includes content (e.g., audio, video, images, etc.) from the communication session and is stored in video recordings database 210 for processing by visual content translation module 150. The visual content translation module includes a video analyzer 220, a text isolator 225, one or more large language models (LLMs) 230 (and/or conventional or other generative artificial intelligence (AI) techniques or tools), an image describer 235, and a soundtrack generator 240. The visual content translation module may further include a voice recordings database 215 that stores voice recordings of a host or presenter of a communication session. The voice recordings of the presenter may be used to audibly or orally present visual aspects of the communication session to listeners (e.g., communication session participants, other users desiring to receive the communication session content, etc.) in the voice of the presenter using any conventional or other text-to-speech conversion devices, tools, and/or techniques. The voice recordings of the presenter for the audible presentation of the visual aspects may be derived from voice recordings database 215 or other sources. Alternatively, a generic voice or a machine generated voice may be used to audibly present the visual aspects to listeners.

For example, an AI or machine learning model may be trained on a person’s voice to describe visual content in that voice to enhance the experience. The machine learning model may be trained on the voice of a communication session and/or over other sessions performed using the same or different system. The machine learning model may include any conventional or other machine learning models (e.g., mathematical/statistical, classifiers, feed-forward, recurrent, convolutional, deep learning, or other neural networks, large language models, etc.).

Video analyzer 220 receives a video recording (e.g., including audio, video, images, etc.) from the video recordings database 210 (or AV content generator 205 for live meetings) and partitions the video into various elements. The video analyzer may employ any conventional or other video processing devices and/or techniques. Soundtrack generator 240 receives the partitioned elements and audio of the video recording from video analyzer 220 and produces audio or oral descriptions of video or visual elements. By way of example, soundtrack generator 240 may utilize text isolator 225 to isolate text from a static image, one or more large language models (LLMs) 230 and/or other generative AI techniques or tools to remove superfluous text from textual content and/or summarize large bodies of text or other activities, and image describer 235 to produce a textual description of objects that are displayed in a presentation area. Image describer 235 may employ any conventional or other generative or other AI techniques and/or tools to interpret a picture or image and produce a textual description (e.g., Describe Picture™, Pallyy™, Google® Goggles/Lens, etc.).

Large language models (LLMs) 230 (and/or other generative AI techniques or tools) may summarize text, understand when semantics of language changes, determine a change in topic, and compare bodies of text for similarities. LLMs 230 enable an audio only presentation of a communication session to be easy to follow and flow well. In addition, an LLM 230 may determine an appropriate time in the audio soundtrack of a communication session to incorporate an audio description of the visual content. LLMs 230 may employ any conventional or other natural language processing techniques and/or machine learning models. The natural language processing techniques may include various techniques (e.g., entity recognition, relationship discovery, semantic analysis, sentiment analysis, part-of-speech (POS) tagging, etc.). The machine learning models may include any conventional or other machine learning models (e.g., mathematical/statistical, classifiers, feed-forward, recurrent, convolutional, deep learning, or other neural networks, large language models, etc.).

By way of example, an LLM 230 may include a neural network that is trained on a vocabulary of text. For example, neural networks may include an input layer, one or more intermediate layers (e.g., including any hidden layers), and an output layer. Each layer includes one or more neurons, where the input layer neurons receive input (e.g., text or text features, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of various text as input and corresponding desired outputs (e.g., summarization, change in semantics, change in topic, comparison result, appropriate time, etc.), where the neural network attempts to produce the provided output and uses an error from the output (e.g., difference between produced and known outputs) to adjust weight (and bias) values (e.g., via backpropagation or other training techniques).

The output layer neurons may indicate a probability for the input data being associated with a corresponding output (e.g., summarization, change in semantics, change in topic, comparison result, appropriate time, etc.). The output with the highest probability may be selected as the result.

Further, soundtrack generator 240 includes a series of plug-ins and a soundtrack builder 249. The plug-ins process text, picture, video, and other types of objects and produce an audio description of the corresponding visual content. The plug-ins may use any conventional or other natural language processing and/or AI or machine learning techniques. The natural language processing techniques may include various techniques (e.g., entity recognition, relationship discovery, semantic analysis, sentiment analysis, POS tagging, etc.). The machine learning models may include any conventional or other machine learning models (e.g., mathematical/statistical, classifiers, feed-forward, recurrent, convolutional, deep learning, or other neural networks, large language models, etc.).

By way of example, soundtrack generator 240 includes a text plug-in 242 to process text, a picture plug-in to process pictures or images, a video plug-in 246 to process video, and one or more other plug-ins 248 to process other types of content or objects. Soundtrack builder 249 incorporates the audio descriptions from plug-ins 242, 244, 246, and 248 into the audio of the communication session at appropriate times or locations as described below.

The output of soundtrack generator 240 is a soundtrack of the communication session including audio descriptions of visual content that is stored in sound recordings database 260. The sound recordings database stores sound recordings for each of the communication sessions that are linked to the original recording and accessed by user 280 (e.g., communication session participant, other user desiring to receive the communication session content, etc.) via meetings/webinars portal 270 when a communication session is to be replayed.

An embodiment interprets video content to augment an audio stream (or soundtrack) of a communication session (e.g., meeting, webinar, etc.). Video of the communication session may include a camera feed of participants, content being shared, and/or other panels. The embodiment interprets and describes content that may be the object of the discussion. Although meetings and webinars may have various formats and widgets (e.g., hang-up, chat, polls, AI summarizations, etc.), the recordings typically have a pre-defined format.

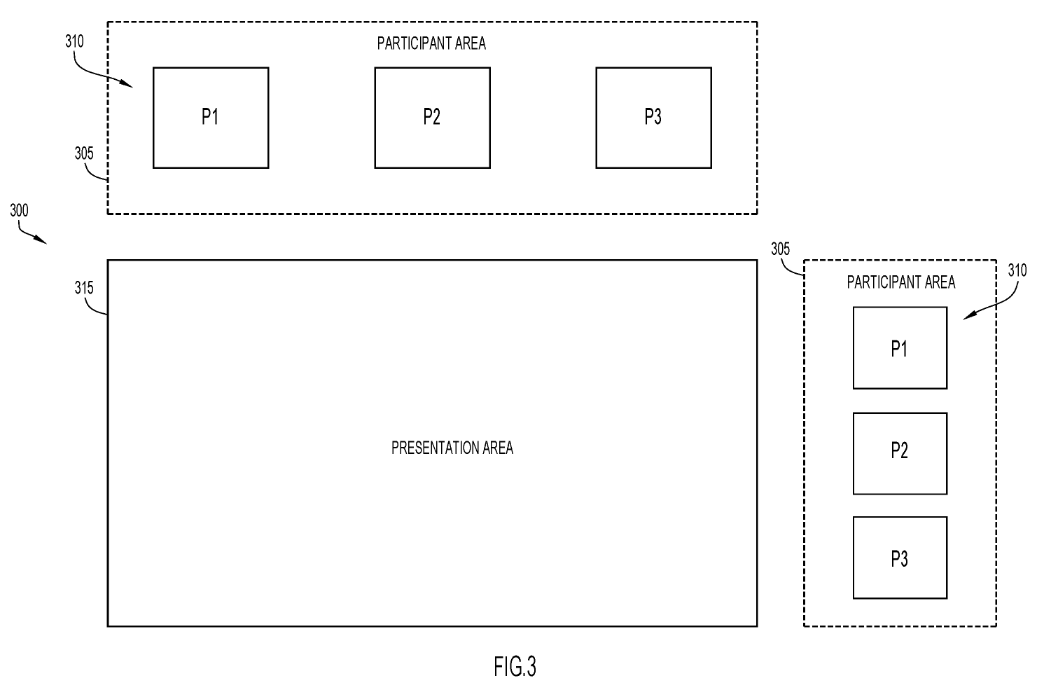

Referring to FIG. 3 by way of example, a user interface screen 300 includes a participant area 305 and a presentation area 315. The participant area may provide various information for participants 310 of a communication session (e.g., participants P1, P2, and P3 as viewed in FIG. 3). The information may include video of the participant.

Presentation area 315 presents content of the communication session shared between participants 310 of participant area 305. The participant area may be disposed adjacent the top or sides of presentation area 315. In some instances when no content is being shared, user interface screen 300 may only present participant area 305 (without presentation area 315).

In an embodiment, visual content translation module 150 typically ignores areas of user interface screen 300 other than presentation area 315. In other words, the visual content translation module interprets the content being shared (provided by presentation area 315) for the communication session. When no content is being shared, the visual content translation module does not interpret content of the communication session.

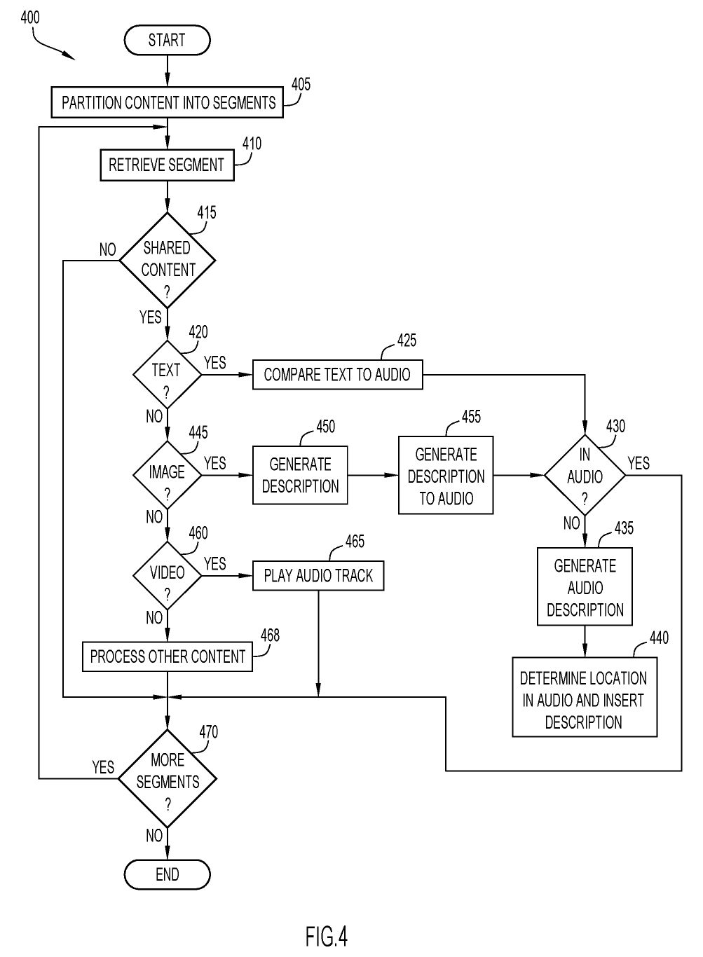

With continued reference to FIGS. 1 - 3, FIG. 4 is a flowchart of a method 400 for incorporating transcribed visual content into audio of a communication session, according to an example embodiment. Initially, AV generator 205 may generate content from a communication session (e.g., meeting, webinar, etc.). The output of the AV content generator may include content from the communication session in the form of a recording (e.g., audio, video, image, etc.) that is stored in video recordings database 210 for processing by visual content translation module 150. Alternatively, the output of AV content generator may include content from a live communication session that is processed by the visual content translation module.

Visual content translation module 150 provides audio descriptions for visual content shared in the communication session. However, there is generally no point in audibly or orally presenting the visual content to a listener (e.g., communication session participant, other user desiring to receive the communication session content, etc.) when a presenter has already orally described the visual content being presented. Accordingly, the visual content translation module produces and utilizes a transcript of an audio stream or soundtrack of the communication session corresponding to sections during which visual content is shared (e.g., start and end times, s(b) and s(e), white-boarding start and end times, w(b) w(e), etc.). LLM 230 (and/or other generative AI techniques or tools) compares the transcript to a textual description of the shared visual content. When LLM 230 (and/or other generative AI techniques or tools) determines that the visual content is sufficiently covered in the transcript (e.g., a threshold quantity of words, semantics, visual content features, etc. of the description are present in the transcript), an audio description of the visual content is not incorporated in the soundtrack. When there are elements of the shared visual content absent from the transcript, an audio description of the absent visual content is produced and incorporated into the soundtrack for the listener. The audio description may include a description of the entire or any portions of the visual content. For example, the description of the entire visual content may be used when one or more portions of the visual content are absent. Further, the description of portions corresponding to the absent portions may be used (instead of the description for the entire visual content).

Video analyzer 220 processes the video content of the communication session (e.g., meeting, webinar, etc.) and partitions the video content into segments or sections at operation 405. The video analyzer may employ any conventional or other video processing devices, tools, and/or techniques to partition the content into different types or categories. The segments may be stored in a database or other storage unit, and include types of no content being shared, static content being shared (e.g., pictures, text, etc.), and video content being shared. Static content includes content which is shared for an extended time period (e.g., greater than 15 seconds or other time period, etc.) and is different from previously played content. The time that the static content started to be displayed, s(b), and the end time, s(e), are retained. When the same static content is presented later, the time of that same static content is not retained as the listener (e.g., communication session participant, other user desiring to receive the communication session content, etc.) does not desire to receive the same content more than once.

Video content may include a video snippet within a window, white-boarding, general screen sharing, or other video related objects. When the video content becomes stationary (even for an extended period of time, such as minutes, etc.), this is still considered video content (and not interpreted for description to the listener). For example, a presenter sharing the screen may move windows, cease window movement, and subsequently continue moving the windows. In this case, the video is considered to be continuous video, as opposed to a frame or image to describe.

The video content may also include white-boarding. White-boarding content is considered as video content until a user has completed providing content. Content creators may add elements to a whiteboard, pause, and then continue. Since intermediate content is not desired for audible description, an embodiment may detect when white-boarding is occurring using any conventional or other video analysis tools (e.g., Lumeo™, etc.) which can be used to determine the type of video content. When white-boarding is detected, the start time, w(b), is captured and analysis continues until the last frame of the white-boarding session. This frame and an end time, w(e), are stored to enable an audio description of the frame to be generated when appropriate.

Visual content translation module 150 considers visual content that is shared in the communication session and context of audio content. The visual content translation module interrupts the audio of the communication session at suitable times as described below to enable visual elements to be audibly shared with a listener (depending on the content being presented). The resulting audio stream is produced to be coherent, while a break in the audio stream occurs at a suitable time and the audible description should be of an appropriate length to describe visual content (without a listener losing the flow of the communication session).

A segment is retrieved and examined to determine the segment type at operation 410. When the segment is shared and includes text as determined at operations 415, 420, the text is compared to audio of the communication session at operation 425. Text isolator 225 captures static text within the visual content (e.g., presented within presentation area 315 of user interface screen 300) using any conventional or other content acquisition tools and/or techniques. The text isolator ignores graphic content, and removes (e.g., via an LLM 230 and/or other generative AI techniques or tools) textual content that is irrelevant to the presentation (e.g., marketing, legal, copyright information, marketing slogans, etc.).

Further, different presenters discuss content differently in a presentation. For example, presenters may read the text verbatim, summarize the text, present the text in a different manner, or ignore the text. Visual content translation module 150 produces and utilizes a transcript of voice or audio from the start to the end of the retrieved segment. The transcript may be produced using any conventional or other speech-to-text techniques. Text plug-in 242, via LLM 230 and/or other generative AI techniques or tools, compares the transcript with the static text within the retrieved segment. When the static text is covered in the audio (or transcript) of the retrieved segment (e.g., threshold similarity, threshold quantity of matching words, semantics, etc.) as determined at operation 430, no audio description of the static text is provided.

When one or more portions of the static text are absent from the transcript for the retrieved segment (e.g., the portions of static text are not present in the audio of the retrieved segment) as determined at operation 430, text plug-in 242 produces an audio description of the absent portions at operation 435. This may be accomplished using any conventional or other text-to-speech techniques and/or tools. For example, when none of the content is described in the presentation (e.g., a presenter may indicate to listeners to read the text), text plug-in 242 may provide an audio description of the text. When there is too much text to audibly present in a short period of time (e.g., 10 seconds or other time interval, etc.), text plug-in 242, via LLM 230 and/or other generative AI techniques or tools, summarizes the text to obtain the main points and produces an audio description of the summary. This may be accomplished using any conventional or other text-to-speech techniques and/or tools.

Further, the audio description may use the voice of the presenter derived from voice recordings database 215. For example, there is typically a primary or dominant speaker and contributions made by other participants during a communication session (e.g., meeting, webinar, etc.). The voice of the dominant participant may be used for audibly or orally presenting the audio description based on user selection. Alternatively, a user may select a different voice (e.g., another user or participant, machine generated voice, etc.) for the audio description to provide contrast relative to the speaker.

Soundtrack builder 249 incorporates the audio description in the audio of the communication session at operation 440. This enables the audio description to be shared with the listener (e.g., communication session participant, other user desiring to receive the communication session content, etc.). For example, the audio description may be shared after the audio of the retrieved segment is played. By way of further example, when none of the content is described in the presentation (e.g., a presenter may indicate to listeners to read the text), an audio description of the text may be provided to the listener just before starting the section of the audio that corresponds to the text.

Soundtrack builder 249 incorporates machine generated speech (or audio descriptions) at appropriate locations or times in the audio stream (or soundtrack) of a communication session (e.g., a listener does not want someone in the communication session (e.g., meeting, webinar, etc.) to be interrupted mid-sentence, etc.). Soundtrack builder 249 may utilize various techniques to select the appropriate time to interrupt the audio stream and incorporate the audio description.

For example, one or more of the following techniques may be used in order of preference from the audio soundtrack and associated transcription. By way of example, the appropriate time may correspond to a change in topic in the shared content. When content is to be shared at the start of visual content, LLM 230 and/or other generative AI techniques or tools may be used to determine when the transcript content (of the retrieved segment) has changed topic. This may not be performed for content to be shared at the end of the visual content since this needs to be incorporated as soon as possible to the end of the content. Another technique may include selecting the appropriate time corresponding to a pause or moment of silence (e.g., 300ms to 1s of silence, etc.). Yet another technique may include selecting the appropriate time corresponding to an end of a sentence.

When the content is not shared or the static text appears in the audio of the retrieved segment as determined at operations 415, 430, or after insertion of an audio description in the audio of the communication session at operation 440, the above process is repeated from operation 410 until the segments have been processed as determined at operation 470.

When the retrieved segment is shared and includes a picture or image (with no text) as determined at operations 415, 445, picture plug-in 244, via image describer 235, produces a textual description of the picture or image at operation 450. Image describer 235 may employ any conventional or other generative or other AI techniques and/or tools to interpret the picture or image and produce a textual description. Visual content translation module 150 produces and utilizes a transcript of voice or audio from the start to the end of the retrieved segment. The transcript may be produced using any conventional or other speech-to-text techniques and/or tools. Picture plug-in 244, via LLM 230 (and/or other generative AI techniques or tools), compares the transcript with the textual description of the image or picture at operation 455. When the textual description of the image is covered in the audio (or transcript) of the retrieved segment (e.g., based on a threshold quantity of words or tokens, semantics, visual content features, etc.) as determined at operation 430, no audio description of the image is provided.

When the textual description of the image or picture is absent from the transcript for the retrieved segment (e.g., a description of the image is not present in the audio of the retrieved segment (e.g., based on a threshold quantity of words or tokens, semantics, visual content features, etc.) as determined at operation 430, picture plug-in 244 produces an audio description of the absent textual description at operation 435. This may be accomplished using any conventional or other text-to-speech techniques and/or tools. Further, the audio description may use the voice of the presenter or other entity derived from voice recordings database 215 in substantially the same manner described above. For example, picture plug-in 244 may analyze content spoken in the audio track for the retrieved segment. When the spoken content lacks a description of the picture, an audio version of the description is produced for a listener. By way of further example, when the visual presentation contains a picture or image with a few words (e.g., including marketing, copyright, etc.), picture plug-in 244 produces a textual description of the picture or image since the marketing/copyright information is removed. When the picture includes a significant amount of words (e.g., above a threshold, etc.), the picture is ignored and the text processed as described above.

As another example, the picture or image may include a last frame snapshot for white-boarding as described above. Picture plug-in 244 analyzes the frame in substantially the same manner described above (e.g., via any conventional or other AI techniques and/or tools, etc.) to interpret the frame and determine relevance (e.g., more than just a scribble, etc.) to produce an audio description of the frame for a listener (from a textual description produced for the frame). For example, the content may be the result of a white-boarding exercise. A transcript of audio of the communication session is analyzed during the time interval of the segment, w(b) to w(e), to compare the frame textual description to the transcript in substantially the same manner described above. When the transcript lacks a description of the frame, an audio description is produced for the frame in substantially the same manner described above.

Soundtrack builder 249 incorporates the audio description at an appropriate location in the audio of the communication session at operation 440 in substantially the same manner described above. This enables the audio description to be shared with the listener (e.g., communication session participant, other user desiring to receive the communication session content, etc.). For example, picture plug-in 244 may analyze content spoken in the audio track for the retrieved segment. When the spoken content lacks a description of the picture, an audio description is produced for a listener at the start of the segment.

When the description of the picture or image appears in the audio of the retrieved segment as determined at operation 430, or after insertion of an audio description in the audio soundtrack of the communication session at operation 440, the above process is repeated from operation 410 until the segments have been processed as determined at operation 470.

When the retrieved segment is shared and includes video as determined at operations 415, 460, video plug-in 246 provides the audio track or soundtrack for the video at operation 465 (while ignoring the video content). In other words, video is considered as a pass-through, where the video content includes an audio track (or soundtrack) and the audio track is simply played while the video is ignored. The above process is repeated from operation 410 until the segments have been processed as determined at operation 470.

When the retrieved segment is shared and includes other types of content besides text, pictures, and video as determined at operations 415, 420, 445, and 460, a corresponding other plug-in 248 processes the content in substantially the same manner described above at operation 468. For example, other plug-in 248 interprets and produces a textual description of the content. Other plug-in 248, via LLM 230 and/or other generative AI techniques or tools, compares a transcript of the retrieved segment with the textual description of the content. When the textual description of the content is covered in the audio (or transcript) of the retrieved segment (e.g., based on a threshold quantity of words or tokens, semantics, content features, etc.), no audio description of the content is provided.

When the textual description of the content is absent from the transcript for the retrieved segment (e.g., a description of the content is not present in the audio of the retrieved segment (e.g., based on a threshold quantity of words or tokens, semantics, content features, etc.), other plug-in 248 produces an audio description of the absent textual description. Further, the audio description may use the voice of the presenter or other entity derived from voice recordings database 215 in substantially the same manner described above. Soundtrack builder 249 incorporates the audio description at an appropriate location in the audio of the communication session in substantially the same manner described above. This enables the audio description to be shared with the listener (e.g., communication session participant, other user desiring to receive the communication session content, etc.). The above process is repeated from operation 410 until the segments have been processed as determined at operation 470.

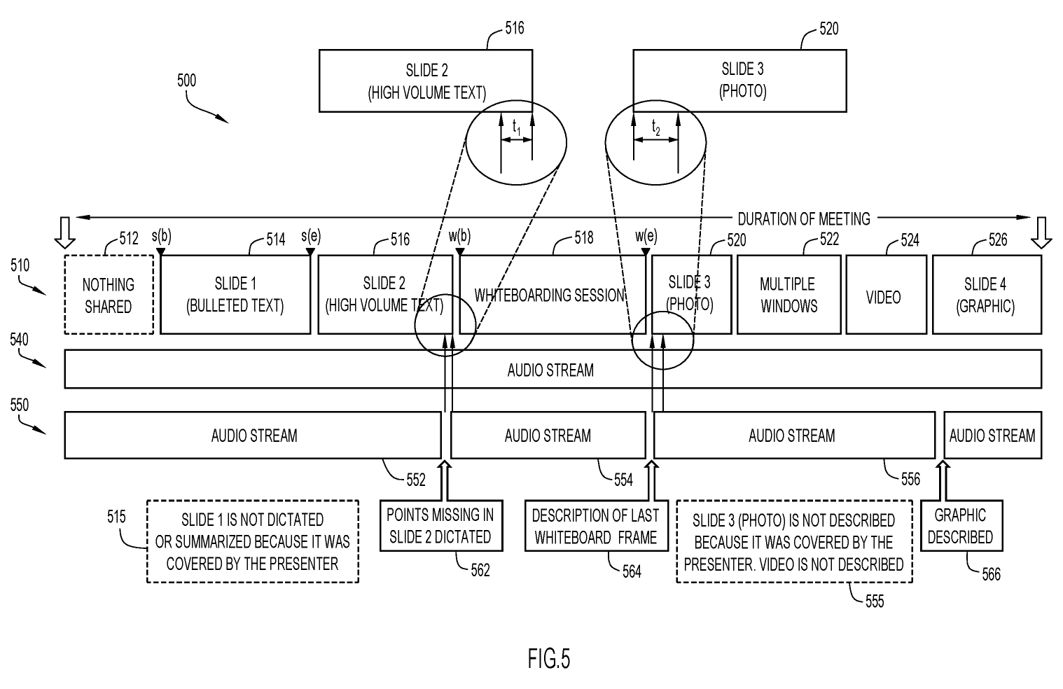

With continued reference to FIGS. 1 - 4, FIG. 5 is a flow diagram of a method 500 for incorporating transcribed visual content into audio of an example communication session, according to an example embodiment. Visual content 510 represents content presented visually during the example communication session (e.g., meeting, webinar, etc.). Original audio stream 540 represents an audio stream from the example communication session. Resulting audio stream 550 represents the audio stream from the example communication session with incorporation of audio descriptions of visual content according to embodiments.

Initially, there is no visual content shared in the communication session at flow 512 and audio of the communication session from original audio stream 540 is just presented in resulting audio stream 550. A first slide is presented in the communication session at flow 514 and visual content translation module 150 determines the first slide to include static text. LLM 230 and/or other generative AI techniques or tools compare a transcript of a presenter (or speaker) of the communication session from a start time, s(b), to an end time, s(e), for the first slide to the contents of the first slide in substantially the same manner described above. In this case, LLM 230 (and/or other generative AI techniques or tools) determines that the content of the first slide is covered in the transcript. Accordingly, an audio description of the first slide is not produced and incorporated into resulting audio stream 550 at flow 515.

The presenter provides a second slide in the communication session at flow 516 which has a high volume of text. Visual content translation module 150 (e.g., via LLM 230 and/or other generative AI techniques or tools) compares the content on the second slide with a transcript of the presenter in substantially the same manner described above. In this case, LLM 230 (and/or other generative AI techniques or tools) determines that one or more portions of the text of the second slide are absent from the transcript. Accordingly, visual content translation module 150 produces an audio description 562 of the absent portions (e.g., of a duration less than ten seconds or other threshold, etc.) and selects an appropriate time 552 to interrupt original audio stream 540 and incorporate the audio description in resulting audio stream 550 (e.g., time t(1) before the end of the second slide as shown in FIG. 5). The appropriate time may be selected based on a silent moment or after the end of a sentence as described above. The audio description may be audibly presented using a simulated voice of the presenter or of a machine as described above. After audible presentation of the audio description, resulting audio stream 550 may resume.

The presenter may subsequently start a white-boarding session in the communication session at flow 518. Visual content translation module 150 detects this session (e.g., using a corresponding plug-in, etc.) and captures the last frame of the whiteboard for which an audio description 564 may be produced in substantially the same manner described above. An appropriate time 554 for interruption of original audio stream 540 and presentation of the audio description of the frame within resulting audio stream 550 is determined, and the audio description is audibly presented (e.g., at a time t(2) after a start of presentation of a third slide at flow 520 as shown in FIG. 5).

The presenter may present a photo or a picture of an object on the third slide in the communication session at flow 520. During the time that the photo or picture is shown, visual content translation module 150 (via LLM 230 and/or other generative AI techniques or tools) compares a transcript of the presenter to an AI generated textual description of the photo in substantially the same manner described above. In this case, LLM 230 (and/or other generative AI techniques or tools) determines that the textual description of the photo was adequately described in the transcript. Accordingly, an audio description of the photo is not produced and incorporated into resulting audio stream 550 at flow 555.

The presenter stops showing the slide deck and starts sharing their screen with multiple windows in the communication session at flow 522. Since this is considered video content, visual content translation module 150 does not provide and incorporate an audio description in resulting audio stream 550 at flow 555 as described above. Subsequently, a video is shared in the communication session at flow 524. In this case, visual content translation module 150 does not provide and incorporate an audio description in resulting audio stream 550 at flow 555 as described above (and enables resulting audio stream 550 to continue).

A subsequent portion of the communication session is a fourth slide including a graphic that the presenter provides at flow 526 but does not describe. In this case, visual content translation module 150 produces an audio description 566 of the graphic that is to interrupt original audio stream 540 and be incorporated into resulting audio stream 550 for audible presentation to the listener at an appropriate time 556 in substantially the same manner described above. The audio description has a suitable duration to prevent interference with the communication session (e.g., ten seconds or other time period, etc.). The audio description occurs at a suitable moment at the start of the portion corresponding to the graphic rather than at the end (e.g., flow 516) since those who would visualize the communication session (e.g., meeting, webinar, etc.) would see the graphic from the start.

The remaining portion of resulting audio stream 550 (corresponding to original audio stream 540) is played through to the end of the communication session. The length or duration of the resulting audio stream 550 is the sum of the durations of original audio stream 540 and the additional audio descriptions 562, 564, 566. Although resulting audio stream 550 is longer than original audio stream 540, a listener has a better appreciation for the content of the communication session (and is not missing as much as listening to original audio stream 540 of the communication session).

Example embodiments may process the audio and visual content of a communication session (e.g., meeting, webinar, etc.) after the communication session is recorded in substantially the same manner described above. However, example embodiments may also apply to live communication sessions (e.g., meetings, webinars, etc.) in substantially the same manner described above where a user is unable to view the visual content which reduces the effectiveness of the communication session. For example, when the communication session is live, determining the appropriate time to incorporate an audio description into the audio stream is more complex since visual content translation module 150 cannot retrospectively observe text. In this case, the visual content translation module selects the appropriate time based on a moment of silence as described above.

Further, during audible presentation of an audio description in a live communication session, a participant is unable to listen to the communication session. In this case, visual content translation module 150 may mark or otherwise indicate that the participant is listening to the audio description of screen content. This informs other participants that the participant is unavailable to answer questions or participate in the communication session.

Moreover, when the audio description for communication session content is audibly presented in a live communication session, the live communication session continues but the participant falls behind or lags the communication session and has to recover. In this case, visual content translation module 150 plays or presents buffered content or audio of the communication session (e.g., after presenting the audio description) at a rate faster than real-time to compensate for the lag (e.g., at 1.5 (or other multiplier) times the rate of presentation of the communication session, etc.). Once the communication session participant has compensated for the lag, the live communication session resumes for the participant at the normal rate and the participant is marked or otherwise visually indicated to the other participants as attentive and live at the meeting.

In addition, the time interval for audible presentation of the audio description is more sensitive for live communication sessions since the participant should not be unavailable for longer than necessary. Accordingly, content summarization may be produced in substantially the same manner described above and utilized more frequently for the audio descriptions for live communication sessions (e.g., always, based on a lower threshold quantity of words relative to the threshold for recorded communication sessions, etc.).

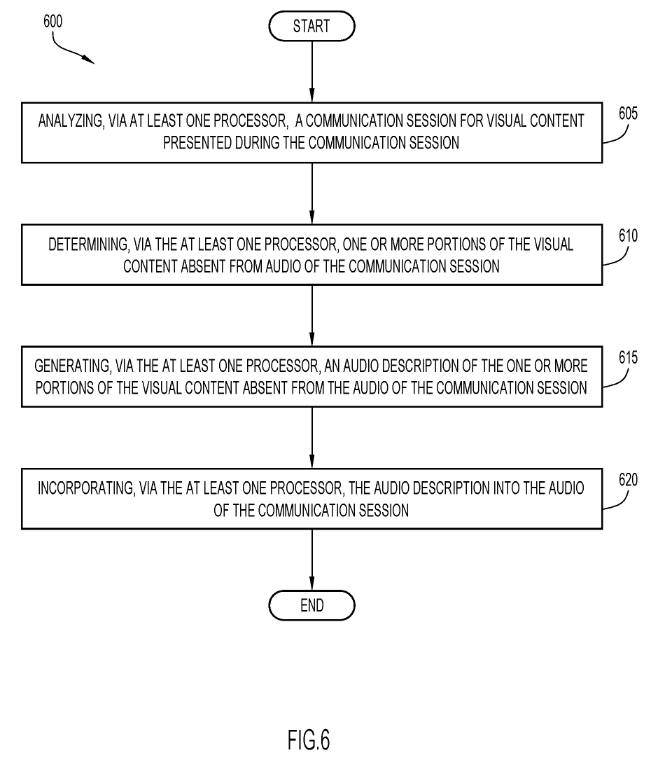

FIG. 6 is a flowchart of an example method 600 for incorporating transcribed visual content into audio of a communication session, according to an example embodiment. At operation 605, a communication session is analyzed, via at least one processor, for visual content presented during the communication session. At operation 610, one or more portions of the visual content absent from audio of the communication session are determined via the at least one processor. At operation 615, an audio description of the one or more portions of the visual content absent from the audio of the communication session are generated via the at least one processor. At operation 620, the audio description is incorporated into the audio of the communication session via the at least one processor.

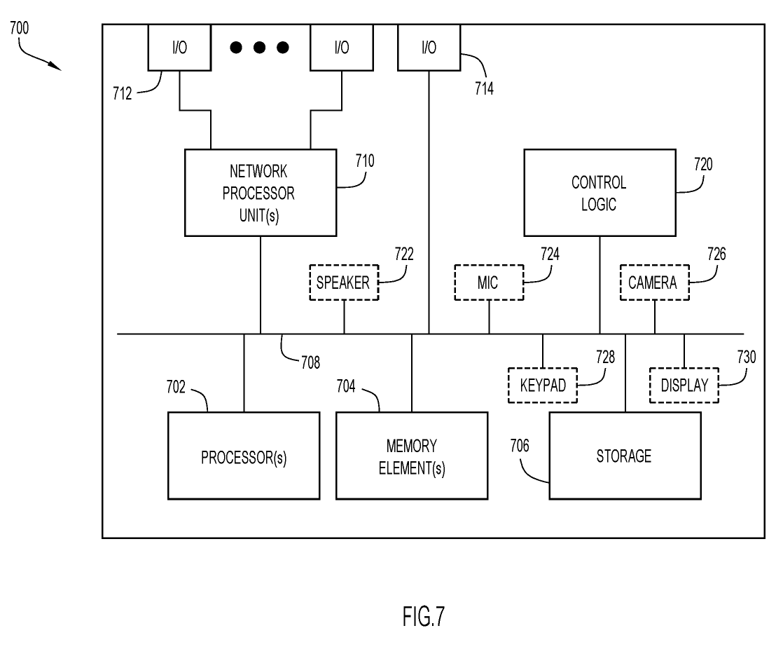

Referring to FIG. 7, FIG. 7 illustrates a hardware block diagram of a computing device 700 that may perform functions associated with operations discussed herein in connection with the techniques depicted in FIGS. 1-6. In various embodiments, a computing device or apparatus or system, such as computing device 700 or any combination of computing devices 700, may be configured as any device entity/entities (e.g., network nodes, computer devices, user devices, servers, client devices, communication devices, network devices, processors, switching devices, network interfaces, etc.) as discussed for the techniques depicted in connection with FIGS. 1-6 in order to perform operations of the various techniques discussed herein.

In at least one embodiment, computing device 700 may be any apparatus that may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory elements 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interfaces 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, network device, network nodes, processors, network interfaces, switching devices, etc.), computing device 700 may further include, or be coupled to, a speaker 722 to convey sound, microphone or other sound sensing device 724, camera or image capture device 726, a keypad or keyboard 728 to enter information (e.g., alphanumeric information, etc.), and/or a touch screen or other display 730. These items may be coupled to bus 708 or I/O interface(s) 714 to transfer data with other elements of computing device 700.

In various embodiments, control logic 720 can include instructions that, when executed, cause processor(s) 702 to perform operations, which can include, but not be limited to, providing overall control operations of computing device 700; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more device entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory elements 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combinations of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: analyzing, via at least one processor, a communication session for visual content presented during the communication session; determining, via the at least one processor, one or more portions of the visual content absent from audio of the communication session; generating, via the at least one processor, an audio description of the one or more portions of the visual content absent from the audio of the communication session; and incorporating, via the at least one processor, the audio description into the audio of the communication session.

In one example, the visual content includes text, and determining one or more portions of the visual content absent from audio of the communication session comprises comparing the text to a transcript of the audio of the communication session to determine the one or more portions of the visual content absent from the audio of the communication session.

In one example, the visual content includes an image, and determining one or more portions of the visual content absent from audio of the communication session comprises generating a textual description of the image, and comparing the textual description of the image to a transcript of the audio of the communication session to determine the one or more portions of the visual content absent from the audio of the communication session.

In one example, incorporating the audio description into the audio of the communication session comprises incorporating the audio description into the audio of the communication session at a time of one of a change in topic of the communication session, a moment of silence, and an end of a sentence.

In one example, the audio description is generated in a voice of a primary speaker of the communication session using a voice database, and the method further comprises filtering, via the at least one processor, irrelevant textual content from the visual content, and providing for video content in the visual content, via the at least one processor, an audio track included in the video content.

In one example, the method further comprises marking, via the at least one processor, a participant of the communication session as unavailable during the communication session when presenting the audio description to the participant.

In one example, the method further comprises presenting, via the at least one processor, the audio description to a participant during the communication session, wherein presenting the audio description produces a lag for the participant relative to the communication session, and presenting, via the at least one processor, buffered content of the communication session to the participant at a rate faster than a real-time rate for the communication session to compensate for the lag.

In another form, an apparatus is provided. The apparatus comprises a network interface to enable communications; memory; and at least one processor configured to perform operations including: analyzing a communication session for visual content presented during the communication session; determining one or more portions of the visual content absent from audio of the communication session; generating an audio description of the one or more portions of the visual content absent from the audio of the communication session; and incorporating the audio description into the audio of the communication session.

In another form, one or more non-transitory computer readable storage media are provided. The one or more non-transitory computer readable storage media are encoded with processing instructions that, when executed by one or more processors, cause the one or more processors to: analyze a communication session for visual content presented during the communication session; determine one or more portions of the visual content absent from audio of the communication session; generate an audio description of the one or more portions of the visual content absent from the audio of the communication session; and incorporate the audio description into the audio of the communication session.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
analyzing, via at least one processor, a communication session for visual content presented during the communication session;
determining, via the at least one processor, one or more portions of the visual content absent from audio of the communication session;
generating, via the at least one processor, an audio description of the one or more portions of the visual content absent from the audio of the communication session; and
incorporating, via the at least one processor, the audio description into the audio of the communication session.

2. The method of claim 1, wherein the visual content includes text, and determining one or more portions of the visual content absent from audio of the communication session comprises:
comparing the text to a transcript of the audio of the communication session to determine the one or more portions of the visual content absent from the audio of the communication session.

3. The method of claim 1, wherein the visual content includes an image, and determining one or more portions of the visual content absent from audio of the communication session comprises:
generating a textual description of the image; and
comparing the textual description of the image to a transcript of the audio of the communication session to determine the one or more portions of the visual content absent from the audio of the communication session.

4. The method of claim 1, wherein incorporating the audio description into the audio of the communication session comprises:
incorporating the audio description into the audio of the communication session at a time of one of a change in topic of the communication session, a moment of silence, and an end of a sentence.

5. The method of claim 1, wherein the audio description is generated in a voice of a primary speaker of the communication session using a voice database, and the method further comprises:
filtering, via the at least one processor, irrelevant textual content from the visual content; and
providing for video content in the visual content, via the at least one processor, an audio track included in the video content.

6. The method of claim 1, further comprising:
marking, via the at least one processor, a participant of the communication session as unavailable during the communication session when presenting the audio description to the participant.

7. The method of claim 1, further comprising:
presenting, via the at least one processor, the audio description to a participant during the communication session, wherein presenting the audio description produces a lag for the participant relative to the communication session; and
presenting, via the at least one processor, buffered content of the communication session to the participant at a rate faster than a real-time rate for the communication session to compensate for the lag.

8. An apparatus comprising:
a network interface to enable communications;
memory; and
at least one processor configured to perform operations including:
analyzing a communication session for visual content presented during the communication session;
determining one or more portions of the visual content absent from audio of the communication session;
generating an audio description of the one or more portions of the visual content absent from the audio of the communication session; and
incorporating the audio description into the audio of the communication session.

9. The apparatus of claim 8, wherein the visual content includes text, and determining one or more portions of the visual content absent from audio of the communication session comprises:
comparing the text to a transcript of the audio of the communication session to determine the one or more portions of the visual content absent from the audio of the communication session.

10. The apparatus of claim 8, wherein the visual content includes an image, and determining one or more portions of the visual content absent from audio of the communication session comprises:
generating a textual description of the image; and
comparing the textual description of the image to a transcript of the audio of the communication session to determine the one or more portions of the visual content absent from the audio of the communication session.

11. The apparatus of claim 8, wherein incorporating the audio description into the audio of the communication session comprises:
incorporating the audio description into the audio of the communication session at a time of one of a change in topic of the communication session, a moment of silence, and an end of a sentence.

12. The apparatus of claim 8, wherein the at least one processor is further configured to perform operations including:
marking a participant of the communication session as unavailable during the communication session when presenting the audio description to the participant.

13. The apparatus of claim 8, wherein the at least one processor is further configured to perform operations including:
presenting the audio description to a participant during the communication session, wherein presenting the audio description produces a lag for the participant relative to the communication session; and
presenting buffered content of the communication session to the participant at a rate faster than a real-time rate for the communication session to compensate for the lag.

14. One or more non-transitory computer readable storage media encoded with processing instructions that, when executed by one or more processors, cause the one or more processors to perform operations including:
analyzing a communication session for visual content presented during the communication session;
determining one or more portions of the visual content absent from audio of the communication session;
generating an audio description of the one or more portions of the visual content absent from the audio of the communication session; and
incorporating the audio description into the audio of the communication session.

15. The one or more non-transitory computer readable storage media of claim 14, wherein the visual content includes text, and determining one or more portions of the visual content absent from audio of the communication session comprises:
comparing the text to a transcript of the audio of the communication session to determine the one or more portions of the visual content absent from the audio of the communication session.

16. The one or more non-transitory computer readable storage media of claim 14, wherein the visual content includes an image, and determining one or more portions of the visual content absent from audio of the communication session comprises:
generating a textual description of the image; and
comparing the textual description of the image to a transcript of the audio of the communication session to determine the one or more portions of the visual content absent from the audio of the communication session.

17. The one or more non-transitory computer readable storage media of claim 14, wherein incorporating the audio description into the audio of the communication session comprises:
incorporating the audio description into the audio of the communication session at a time of one of a change in topic of the communication session, a moment of silence, and an end of a sentence.

18. The one or more non-transitory computer readable storage media of claim 14, wherein the audio description is generated in a voice of a primary speaker of the communication session using a voice database, and the processing instructions further cause the one or more processors to perform operations including:
filtering irrelevant textual content from the visual content; and
providing for video content in the visual content an audio track included in the video content.

19. The one or more non-transitory computer readable storage media of claim 14, wherein the processing instructions further cause the one or more processors to perform:
marking a participant of the communication session as unavailable during the communication session when presenting the audio description to the participant.

20. The one or more non-transitory computer readable storage media of claim 14, wherein the processing instructions further cause the one or more processors to perform operations including:
presenting the audio description to a participant during the communication session, wherein presenting the audio description produces a lag for the participant relative to the communication session; and
presenting buffered content of the communication session to the participant at a rate faster than a real-time rate for the communication session to compensate for the lag.
